(19) United States
(12) Patent Application Publication
(10) Pub. No.: US 2024/0160957 A1
(43) Pub. Date: May 16, 2024

(54) SYSTEMS AND METHODS TO DESIGN A FOCUSED KNOWLEDGE GRAPH FOR GRAPH MACHINE LEARNING APPROACHES

(71) Applicant: Accenture Global Solutions Limited, Dublin (IE)

(72) Inventors: Christophe GUERET, Co. Dublin (IE); Luca COSTABELLO, Newbridge (IE)

(21) Appl. No.: 18/054,708

(22) Filed: Nov. 11, 2022

(51) Int. Cl. G06N 5/02

(52) U.S. Cl. CPC G06N 5/022

(57) ABSTRACT

A device may process an external knowledge graph (KG) based on a graph construction strategy to generate a focus KG. The device may utilize a graph machine learning model to generate a ranked list of candidate links based on the focus KG, and may process the focus KG, with a graph content analysis model, to generate context, density, and balance scores. The device may process the ranked list of candidate links and a gold standard set of links, with a performance analysis model, to generate a performance score for the ranked list of candidate links, and may generate a modified graph construction strategy based on the context score, the density score, the balance score, and the performance score. The device may generate a list of candidate links based on the modified graph construction strategy, and may train a KG embedding model with the modified ranked list of candidate links.

### BACKGROUND

A knowledge graph (KG) is a graph dataset of directed, labeled edges that connect nodes representing concepts (e.g., people, products, companies, genes, proteins, and/or the like). Two nodes may be connected by multiple edges with distinct labels, and such a knowledge graph may be referred to as a multi-relational graph.

### SUMMARY

Some implementations described herein relate to a method. The method may include receiving an external knowledge graph, a graph construction strategy, and a list of candidate links, and processing the external knowledge graph based on the graph construction strategy to generate a focused knowledge graph. The method may include utilizing a graph machine learning model to generate a ranked list of candidate links based on the focused knowledge graph and the list of candidate links, and processing the focused knowledge graph, with a graph content analysis model, to generate a context score, a density score, and a balance score for the focused knowledge graph. The method may include processing the ranked list of candidate links and a gold standard set of links, with a performance analysis model, to generate a performance score for the ranked list of candidate links, and determining whether to perform an extension approach or a filtering approach on the graph construction strategy based on the context score, the density score, the balance score, and the performance score. The method may include performing the extension approach or the filtering approach on the graph construction strategy to generate a modified graph construction strategy, and generating a modified focused knowledge graph based on the modified graph construction strategy. The method may include generating a modified ranked list of candidate links based on the modified focused knowledge graph, and training a knowledge graph embedding (KGE) model, with the modified ranked list of candidate links, to generate a trained KGE model.

Some implementations described herein relate to a device. The device may include one or more memories and one or more processors coupled to the one or more memories. The one or more processors may be configured to receive an external knowledge graph, a graph construction strategy, and a list of candidate links, and process the external knowledge graph based on the graph construction strategy to generate a focused knowledge graph. The one or more processors may be configured to utilize a graph machine learning model to generate a ranked list of candidate links based on the focused knowledge graph and the list of candidate links, and process the focused knowledge graph, with a graph content analysis model, to generate a context score, a density score, and a balance score for the focused knowledge graph. The one or more processors may be configured to process the ranked list of candidate links and a gold standard set of links, with a performance analysis model, to generate a performance score for the ranked list of candidate links, and determine whether to perform an extension approach or a filtering approach on the graph construction strategy based on the context score, the density score, the balance score, and the performance score. The one or more processors may be configured to perform the extension approach or the filtering approach on the graph construction strategy to generate a modified graph construction strategy, and generate a modified focused knowledge graph based on the modified graph construction strategy. The one or more processors may be configured to generate a modified ranked list of candidate links based on the modified focused knowledge graph, and train a KGE model, with the modified ranked list of candidate links, to generate a trained KGE model. The one or more processors may be configured to cause the trained KGE model to be implemented.

Some implementations described herein relate to a non-transitory computer-readable medium that stores a set of instructions for a device. The set of instructions, when executed by one or more processors of the device, may cause the device to receive an external knowledge graph, a graph construction strategy, and a list of candidate links, and process the external knowledge graph based on the graph construction strategy to generate a focused knowledge graph. The set of instructions, when executed by one or more processors of the device, may cause the device to utilize a graph machine learning model to generate a ranked list of candidate links based on the focused knowledge graph and the list of candidate links, and process the focused knowledge graph, with a graph content analysis model, to generate a context score, a density score, and a balance score for the focused knowledge graph. The set of instructions, when executed by one or more processors of the device, may cause the device to process the ranked list of candidate links and a gold standard set of links, with a performance analysis model, to generate a performance score for the ranked list of candidate links, and determine whether to perform an extension approach or a filtering approach on the graph construction strategy based on the context score, the density score, the balance score, and the performance score. The set of instructions, when executed by one or more processors of the device, may cause the device to perform the extension approach on the graph construction strategy to generate a modified graph construction strategy based on the context score failing to satisfy a context threshold, and perform the filtering approach on the graph construction strategy to generate the modified graph construction strategy based on the balance score failing to satisfy a balance threshold or on the performance score failing to satisfy a performance threshold. The set of instructions, when executed by one or more processors of the device, may cause the device to generate a modified focused knowledge graph based on the modified graph construction strategy, and generate a modified ranked list of candidate links based on the modified focused knowledge graph. The set of instructions, when executed by one or more processors of the device, may cause the device to train a KGE model, with the modified ranked list of candidate links, to generate a trained KGE model.

### BRIEF DESCRIPTION OF THE DRAWINGS

FIGS. 1A-1H are diagrams of an example implementation described herein.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for identifying training data for training a KGE model.

### DETAILED DESCRIPTION

The following detailed description of example implementations refers to the accompanying drawings. The same reference numbers in different drawings may identify the same or similar elements.

In-silico hypothesis generation is the adoption of machine learning models to create plausible hypotheses (e.g., biological hypotheses) from large datasets (e.g., biomedical datasets). Such hypotheses are inferred from the data stored in the datasets and are provided to researchers to validate the hypotheses (e.g., with laboratory studies). A knowledge graph may be utilized to represent datasets (e.g., biomedical datasets). A triple is a fact or a link defined as t=(s, p, o), where s is a subject, p is a predicate, and o is an object. An embedding is a k-dimensional vector of real numbers that represents either a node or an edge of a knowledge graph. Embeddings are learned by neural networks (e.g., a knowledge graph embedding (KGE) model) and serve as internal representations of concepts learned from the knowledge graph. A KGE model is a neural network architecture (e.g., a neural link predictor) that learns vector representations (e.g., embeddings) of concepts from training a knowledge graph to predict missing, unseen links between nodes. The training phase of a KGE model attempts to minimize a loss layer that includes a scoring layer (e.g., a method-specific function that assigns a plausibility score to a triple). The goal of the training phase is to learn optimal embeddings, such that the scoring layer is able to assign high scores to positive statements and low scores to statements unlikely to be true.

Graph machine learning may include a family of machine learning methods designed to learn from graph datasets with a goal of inferring missing information (e.g., predicting missing edges between nodes of a knowledge graph). Graph machine learning includes node representation learning models based on graph features, graph neural networks (GNNs), and neural link predictors. Defining a focused training knowledge graph (hereafter referred to as “focused graph”) for a graph machine learning approach is time consuming and utilizes significant resources. For example, a link prediction task to identify new “acts on” links between nodes of a first type (e.g., a “drug”) and nodes of a second type (e.g., a “protein”) requires defining the most informative content to include in a training knowledge graph. While there is an abundance of data readily available for training data (e.g., a training knowledge graph), selecting the most informative content for the training data of a neural link predictor is a difficult and time-consuming task for a knowledge scientist and a person with a deep understanding of background knowledge (e.g., a person with a medical degree).

Therefore, current techniques for identifying training data for a KGE model consume computing resources (e.g., processing resources, memory resources, communication resources, and/or the like), networking resources, and/or the like associated with failing to select the most informative content for the training data, generating an incomplete KGE model based on training the KGE model with insufficient training data, discovering the incomplete KGE model and the insufficient training data, supplementing the insufficient training data and retraining the KGE model with the supplemented training data, and/or the like.

Some implementations described herein relate to a training system that identifies training data for training a KGE model. For example, the training system may receive an external knowledge graph, a graph construction strategy, and a list of candidate links, and may process the external knowledge graph based on the graph construction strategy to generate a focused knowledge graph. The training system may utilize a graph machine learning model to generate a ranked list of candidate links based on the focused knowledge graph and the list of candidate links, and may process the focused knowledge graph, with a graph content analysis model, to generate a context score, a density score, and a balance score for the focused knowledge graph. The training system may process the ranked list of candidate links and a gold standard set of links, with a performance analysis model, to generate a performance score for the ranked list of candidate links, and may determine whether to perform an extension approach or a filtering approach on the graph construction strategy based on the context score, the density score, the balance score, and the performance score. The training system may perform the extension approach on the graph construction strategy to generate a modified graph construction strategy based on the context score failing to satisfy a context threshold, and may perform the filtering approach on the graph construction strategy to generate the modified graph construction strategy based on the balance score failing to satisfy a balance threshold or on the performance score failing to satisfy a performance threshold. The training system may generate a modified focused knowledge graph based on the modified graph construction strategy, and may generate a modified ranked list of candidate links based on the modified focused knowledge graph. The training system may train a KGE model, with the modified ranked list of candidate links, to generate a trained KGE model.

In this way, the training system identifies training data for training a KGE model. For example, the training system may provide a support decision system for a design of content of knowledge graphs (e.g., training data) used for graph machine learning techniques. The training system may create a focused knowledge graph (e.g., that predicts a specific link type) via a declarative graph construction strategy that creates the focused knowledge graph and via an analytics subsystem that analyzes content of the focused knowledge graph and performance of machine learning predictions based on the focused knowledge graph. Thus, the training system addresses the technical problems associated with the current techniques for updating a KGE model. This, in turn, conserves computing resources, networking resources, and/or the like that would otherwise have been consumed in failing to select the most informative content for the training data, generating an incomplete KGE model based on training the KGE model with insufficient training data, discovering the incomplete KGE model and the insufficient training data, supplementing the insufficient training data and retraining the KGE model with the supplemented training data, and/or the like.

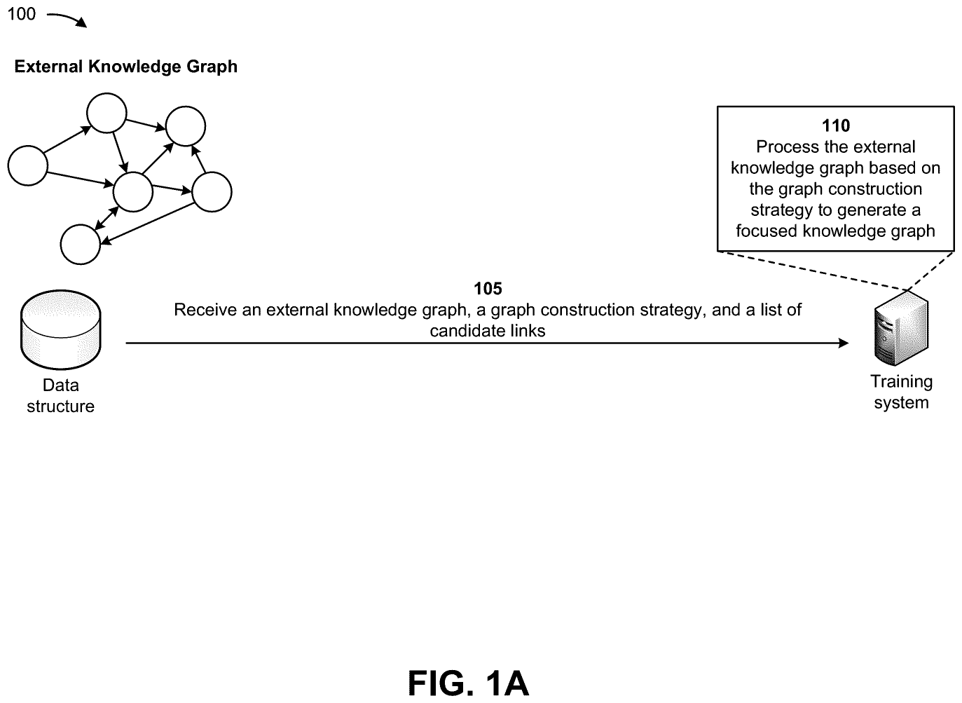

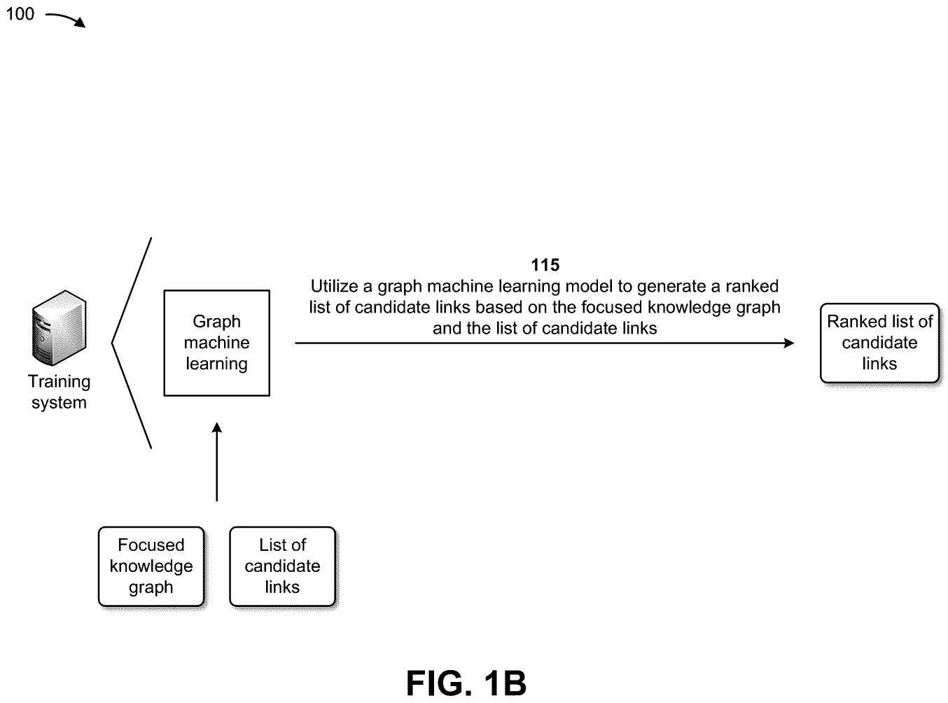

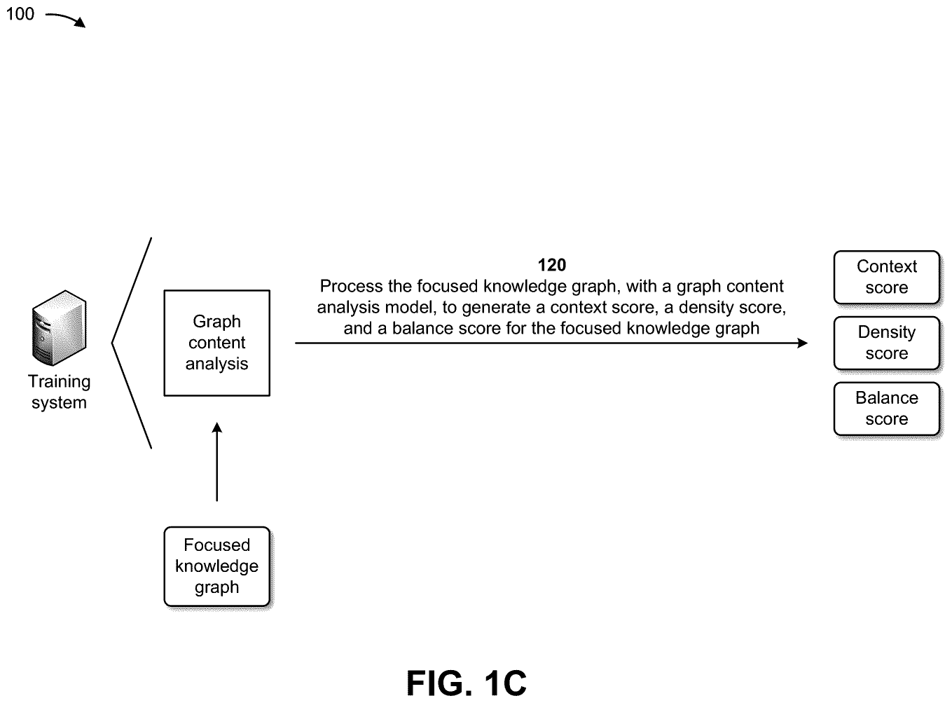

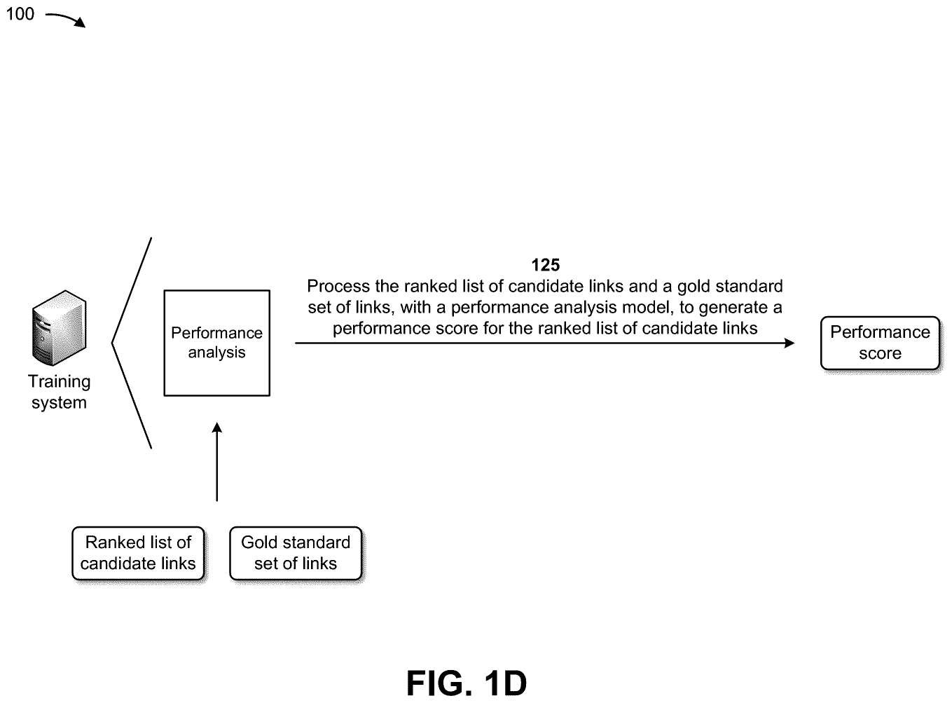

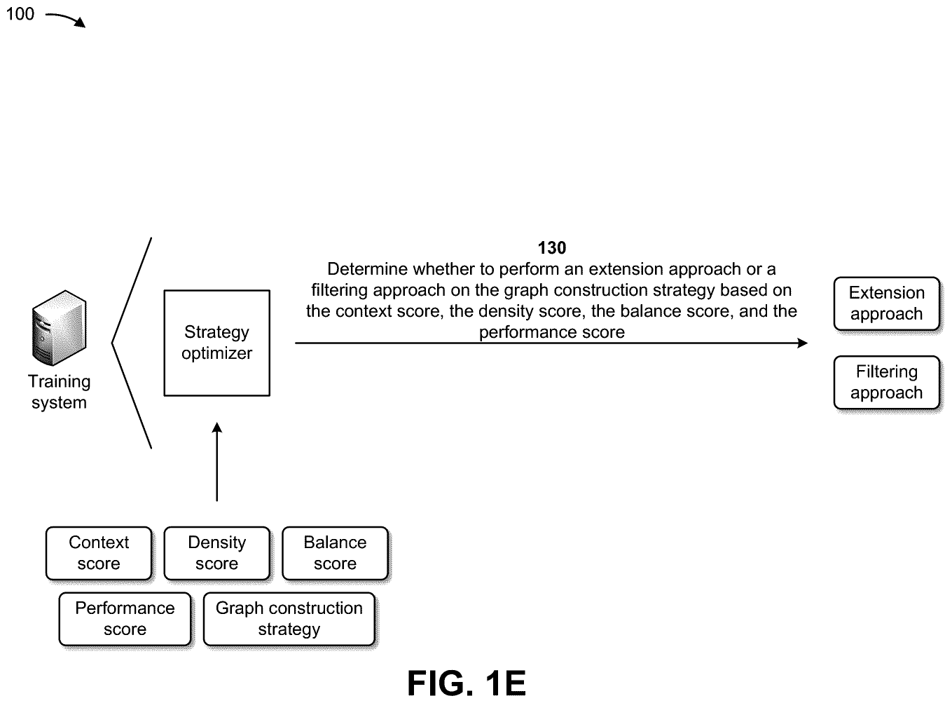

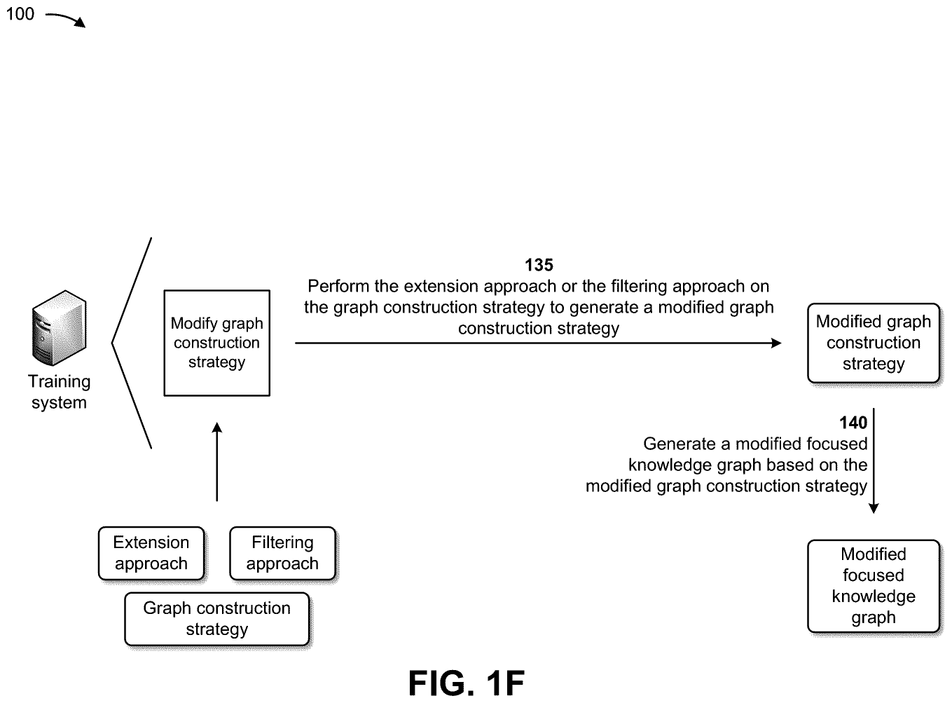

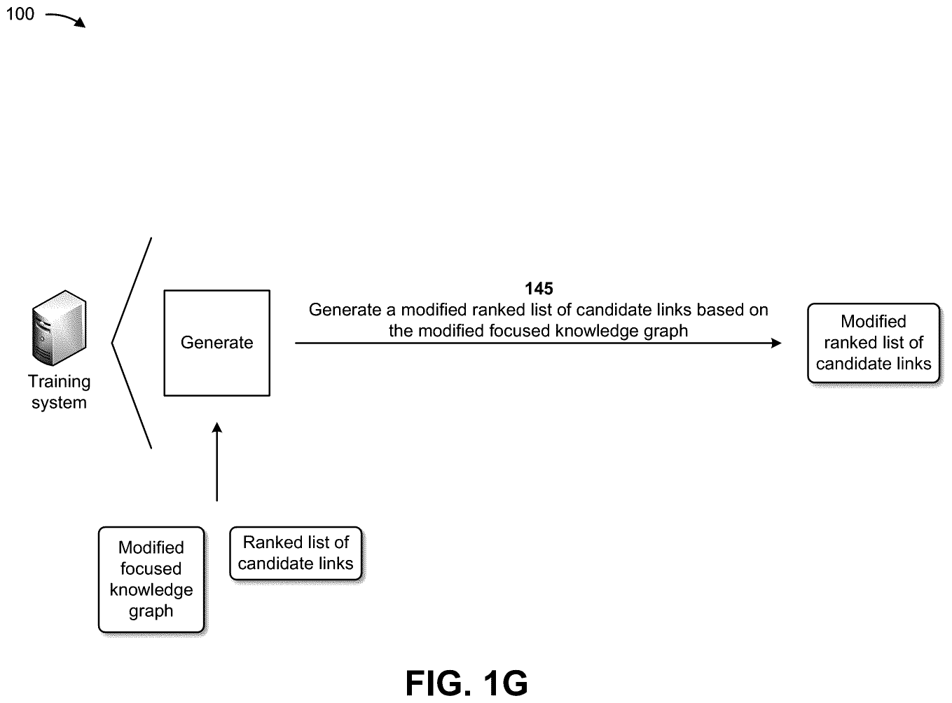

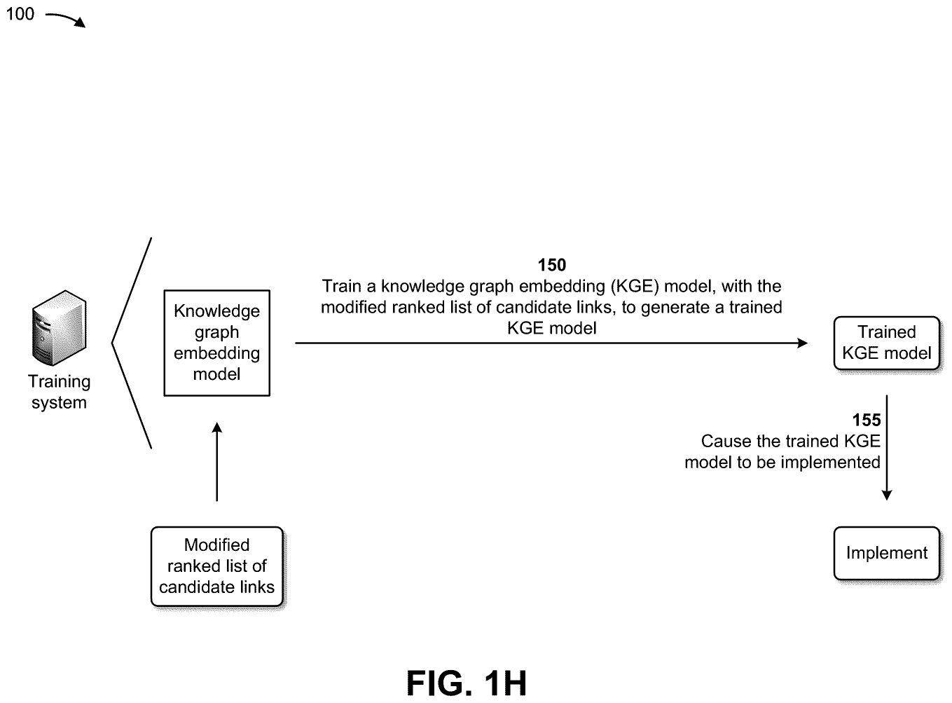

FIGS. 1A-1H are diagrams of an example 100 associated with identifying training data for training a KGE model. As shown in FIGS. 1A-1H, example 100 includes a training system associated with a data structure. The training system may include a system that identifies training data for training a KGE model. Further details of the training system and the data structure are provided elsewhere herein.

As shown in FIG. 1A, and by reference number 105, the training system may receive an external knowledge graph, a graph construction strategy, and a list of candidate links. For example, a data structure (e.g., a database, a table, a list, and/or the like) may store the external knowledge graph, the graph construction strategy, and the list of candidate links. The training system may request the external knowledge graph, the graph construction strategy, and the list of candidate links from the data structure, and may receive the external knowledge graph, the graph construction strategy, and the list of candidate links based on the request. Alternatively, a user of the training system may input the external knowledge graph, the graph construction strategy, and the list of candidate links to a computing device, and may cause the computing device to provide the external knowledge graph, the graph construction strategy, and the list of candidate links to the training system.

The external knowledge graph may include a graph dataset of directed, labeled edges that connect nodes representing concepts (e.g., people, products, companies, genes, proteins, and/or the like). The external knowledge graph may be utilized to represent a dataset, such as a biomedical dataset that includes information associated with diseases, genes, gene variants, biological processes, proteins, and/or the like. In some implementations, the external knowledge graph may include a knowledge graph provided by clinical knowledge graph (CKG), PubChem, Hetionet, and/or the like.

The graph construction strategy may include a previously used graph construction strategy, a new graph construction strategy, and/or the like. The graph construction strategy may include a set of queries (e.g., using standard language SPARQL) executed in sequence and that eventually scope execution to content of a knowledge graph being constructed. For example, the graph construction strategy may include predicting a drug that acts on a target. The graph construction strategy may extract from the external knowledge graph all connections of this type. This part of the graph construction strategy may be implemented as:

```
CONSTRUCT {
  ?drug a :Drug
  ?target a :Target
  ?drug :acts_on ?target
} FROM <external> WHERE {
  ?drug a :Drug
  ?target a :Target
  ?drug :acts_on ?target
}.
```

The list of candidate links may include a list of links (e.g., provided by a user of the training system) indicating a set of hypotheses to test. Each of the candidate links may include a link (e.g., an edge) that may be added to the external knowledge graph.

As further shown in FIG. 1A, and by reference number 110, the training system may process the external knowledge graph based on the graph construction strategy to generate a focused knowledge graph. For example, the training system may execute the set of queries of the graph construction strategy with the external knowledge graph to generate the focused knowledge graph (e.g., a subset of the external knowledge graph). The training system may execute the set of queries of the graph construction strategy in sequence until the focused knowledge graph is generated from the external knowledge graph.

As shown in FIG. 1B, and by reference number 115, the training system may utilize a graph machine learning model to generate a ranked list of candidate links based on the focused knowledge graph and the list of candidate links. For example, the training system may process the focused knowledge graph and the list of candidate links, with the graph machine learning model, to generate the ranked list of candidate links. In some implementations, when utilizing the graph machine learning model to generate the ranked list of candidate links, the training system may perform link predictions for the list of candidate links based on the focused knowledge graph, and may rank the list of candidate links based on the link predictions to generate the ranked list of candidate links. Each of the link predictions may include a percentage likelihood of a candidate link being generated by a KGE model (e.g., 95%, 97%, 80%, 88%, 49%, 62%, and/or the like). In some implementations, the ranked list of candidate links may be ranked from the highest percentage likelihood to a lowest percentage likelihood (e.g., 97%, 95%, 88%, 80%, 62%, 49%, and/or the like).

As shown in FIG. 1C, and by reference number 120, the training system may process the focused knowledge graph, with a graph content analysis model, to generate a context score, a density score, and a balance score for the focused knowledge graph. For example, in order for a graph machine learning model to perform correctly on a link prediction task for the focused knowledge graph, the focused knowledge graph may typically need to exhibit context (e.g., a network of links around a target link for a prediction task), density (e.g., a topology more akin to a web than to a tree), and balance (e.g., an equivalent amount of information for each type of node). In order to determine whether the focused knowledge graph exhibits context, density, and balance, the training system may process the focused knowledge graph, with the graph content analysis model, to generate the context score, the density score, and the balance score for the focused knowledge graph.

With regard to the context score, the training system may measure an average path length of the focused knowledge graph between two target concept types. For example, the average path length may include a length between any pair of “drug” and “target.” Some of the paths may be an “acts on” link at a length of one, but other instances of the “drug” and “target” pair may be connected via longer and indirect paths. The average path length may be between zero, if two nodes are not connected, to any number greater than zero corresponding to an average quantity of links connecting nodes. For example, for a focused knowledge graph G with n connections between a set of nodes E, the average path length (apl) may be calculated as follows:

$$apl ( G ) = \frac{1}{n \cdot ( n - 1 )} \cdot {Σ}_{u \neq v ∈ V} distance ( u , v ) ,$$

where distance (u, v) corresponds to a length of a shortest path between nodes u and v. For graph machine learning, there may be a particular number for the average path length that provides the best results. At zero there is not enough context to learn anything but if the average path length is too high then information may too distant to be learned. In some implementations, the particular number may be set to a default value (e.g., three). An objective of the particular number is to determine a balance between being too narrow (e.g., only allow direct links) and too broad (e.g., ending up with a factually correct but too vague logic).

In order to normalize the average path length between a score of zero (e.g., worst) and one (e.g., best), the training system may define around the particular number. For example, average path lengths around one and three may provide the better context scores, and average path lengths of two may provide the best context scores. Average path lengths less than one or greater than three may generate context scores of zero. An equation for Gaussian mapping and computation of a context score (e.g., context(G)) may be:

$$context ( G ) = \frac{1}{σ \sqrt{2 π}} exp ( \frac{- {( apl ( G ) - μ )}^{2}}{2 {σ}^{2}} ) ,$$

where a parameter μ is set to two and a parameter σ² is set to one.

With regard to the density score, the training system may assess the density of the focused knowledge graph via a metric of a clustering coefficient. A clustering coefficient measures a quantity of triangular relationships present in the focused knowledge graph. A tree-like knowledge graph has zero triangular relationships, whereas a more densely connected knowledge graph may include several triangular relationships. A local version of the metric may focus on a quantity of triangles around a particular node of a knowledge graph, and a global version of the metric may perform an average measure over an overall knowledge graph. The training system may utilize the global version of the metric to obtain density scores (e.g., density(G)) between zero (e.g., worst) and one (e.g., best) according to the following equation:

$$density ( G ) = \frac{3 * quantity of triangles}{n} .$$

The training system may assume that density increases a quality of a machine learning output.

With regard to balance score, the training system may utilize a degree distribution of the knowledge graph to determine balance scores. A degree of a node is a quantity of edges connected to the node (e.g., incoming edges and outgoing edges). A degree distribution is a histogram plot with different values of node degrees (e.g., from zero to the greatest degree in the knowledge graph) on the x-axis and cumulative frequencies of observations of the node degrees on the y-axis. Most degree distributions may follow a pattern of a Zipf's law (e.g., an empirical law that refers to the fact that for many types of data, a rank-frequency distribution is an inverse relation), with 20% of the degree values being found in 80% of the nodes of the focused knowledge graph. In a target use-case this would mean an unbalanced knowledge graph with a few very well-connected nodes and many more nodes without connections. The training system specifies a degree distribution that follows a power law characteristic of scale-free networks. These network topologies get their name “scale free” from the fact that they can be observed at any scale (e.g., from a lowest scale where the entire network is shown, to zooming out performed by collapsing nodes by degrees), and the network topology remains with the same degree distribution.

A knowledge graph exhibiting a scale-free degree distribution may be better for graph machine learning. High-degree nodes may tend to be connected to similarly dense nodes and thus may provide enough information for a KGE model to learn an effective vector representation. The training system may calculate the balance score (e.g., balance (G)) with the following equation:

$$balance ( G ) = \frac{{Σ}_{( u , v ) ∈ E} deg ( u ) \cdot deg ( v )}{{S}_{max}}$$

where deg(·) corresponds to a degree of a node and Sₘₐₓ corresponds to a maximum value of the numerator for a set of all knowledge graphs with a degree distribution identical to that of knowledge graph G. The balance score may be generated using a formula to create a scale-free network with a specific target network size matching that of knowledge graph G. The balance score may include a value between zero and one, with zero indicating a network very dependent on a scale of observation (e.g., and thus heavily unbalanced), and values closer to one corresponding to a more balanced scale-free network.

As shown in FIG. 1D, and by reference number 125, the training system may process the ranked list of candidate links and a gold standard set of links, with a performance analysis model, to generate a performance score for the ranked list of candidate links. For example, the training system may focus on an output (e.g., the ranked list of candidate links) for training the KGE model rather than the focused knowledge graph. In some implementations, the training system may utilize other performance metrics (e.g., specific performance metrics unrelated to the objective of a ranked list of candidate links) to determine whether the KGE model learned something. The training system may utilize the performance score to determine whether the KGE model can generate valid predictions. The training system may utilize the gold standard set of links to determine whether the KGE model predicts the gold standard set of links. The gold standard set of links may not be generated from training data and may be evaluated the same way a final output is produced by the KGE model.

For example, the training system may receive the gold standard D set of m links. The links in the gold standard set of links connecting, for example, the drug and target pairs, are known to be true. In some implementations, the gold standard set of links may be automatically extracted from the external knowledge graph. For best results, the gold standard set of links should cover different parts of the external knowledge graph and not remove blocks of data. For example, making the gold standard set of links with all links between drugs and a particular gene may severely impair making any future prediction for a particular gene and may provide a very biased way of assessing the performance of the predictions. The training system may calculate the performance score (e.g., performance (D)) with the following equation:

$$performance ( D ) = \frac{m * ( m + 1 )}{2 * {Σ}_{e ∈ D} rank ( e )} .$$

As shown in FIG. 1E, and by reference number 130, the training system may determine whether to perform an extension approach or a filtering approach on the graph construction strategy based on the context score, the density score, the balance score, and the performance score. For example, the training system may utilize the context score, the density score, the balance score, and the performance score to modify the graph construction strategy. In some implementations, the training system may utilize the extension approach or the filtering approach to modify the graph construction strategy based on the context score, the density score, the balance score, and the performance score. The training system may determine whether to utilize the extension approach or the filtering approach to modify the graph construction strategy. The extension approach may include adding more edges and edge types to the graph construction strategy. The filtering approach may include being more selective on instances of different edge types present in the graph construction strategy. In some implementations, the training system may utilize the extension approach or the filtering approach to modify the graph construction strategy when the performance score fails to satisfy a threshold (e.g., a low performance score). The training system may determine whether to utilize the extension approach or the filtering approach based on the context score, the density score, and the balance score.

The training system may utilize the extension approach when the context score fails to satisfy a threshold (e.g., a low context score). A low context score may indicate a lack of (e.g., indirect) connectivity between two sets of nodes. For example, the training system may determine that the concepts of “condition” and “pathway” are meaningful ways to indirectly connect “drug” and “target.” The extension approach may add extra edges to the graph construction strategy. For example, the addition of the extra edges may occur via the addition of a new SPARQL query for a link between drug and condition:

```
CONSTRUCT {
  ?drug a :Drug
  ?condition a :Condition
  ?drug :has_indication ?condition
} FROM <external> WHERE {
  ?drug a :Drug
  ?condition a :Condition
  ?drug :has_indication ?condition
}.
```

The training system may utilize the filtering approach when the balance score fails to satisfy a threshold (e.g., a low balance score). For example, if the training system identifies one thousand nodes of type “condition” but only one hundred of the nodes (e.g., 10%) have a connection to a pathway, this may indicate that all the other “condition” types do not have a documented pathway of action, though they may have been added to the focused knowledge graph via a prescription of a drug for them. Such an example may result in a low balance score and may trigger some poor performance as the KGE model may attempt to optimize nine hundred nodes for which little information is known. This is a waste of performance and computing power and resources. In such an example, the training system may utilize the filtering approach to filter out (e.g., eliminate) the nine hundred nodes from the graph construction strategy by utilizing them as a filter with a SPARQL keyword “VALUES”:

```
CONSTRUCT {
  ?drug a :Drug
  ?condition a :Condition
  ?drug :has_indication ?condition
} FROM <external> WHERE {
  ?drug a :Drug
  ?condition a :Condition
  ?drug :has_indication ?condition
  VALUES ?condition { <A> <B> <C> }
}.
```

This modified version of the query may only identify “has_indication” links related to the conditions A, B, and C.

As shown in FIG. 1F, and by reference number 135, the training system may perform the extension approach or the filtering approach on the graph construction strategy to generate a modified graph construction strategy. For example, the training system may utilize the extension approach when the context score fails to satisfy a threshold (e.g., a low context score), and may generate the modified graph construction strategy based on the extension approach, as described above in connection with FIG. 1E. Alternatively, the training system may utilize the filtering approach when the balance score fails to satisfy a threshold (e.g., a low balance score), and may generate the modified graph construction strategy based on the extension approach, as described above in connection with FIG. 1E.

As further shown in FIG. 1F, and by reference number 140, the training system may generate a modified focused knowledge graph based on the modified graph construction strategy. For example, the training system may process the focused knowledge graph based on the modified graph construction strategy to generate the modified focused knowledge graph. In some implementations, the training system may execute the set of queries of the modified graph construction strategy with the focused knowledge graph to generate the modified focused knowledge graph. The training system may execute the set of queries of the modified graph construction strategy in sequence until the modified focused knowledge graph is generated from the focused knowledge graph.

As shown in FIG. 1G, and by reference number 145, the training system may generate a modified ranked list of candidate links based on the modified focused knowledge graph. For example, the training system may utilize the graph machine learning model to generate the modified ranked list of candidate links based on the modified focused knowledge graph and the ranked list of candidate links. In some implementations, the training system may process the modified focused knowledge graph and the ranked list of candidate links, with the graph machine learning model, to generate the modified ranked list of candidate links. In some implementations, when utilizing the graph machine learning model to generate the modified ranked list of candidate links, the training system may perform link predictions for the ranked list of candidate links based on the modified focused knowledge graph, and may re-rank the ranked list of candidate links based on the link predictions to generate the modified ranked list of candidate links.

As shown in FIG. 1H, and by reference number 150, the training system may train a KGE model, with the modified ranked list of candidate links, to generate a trained KGE model. For example, the training system may generate the trained KGE model based on applying the modified graph construction strategy. In some implementations, the training system may divide the modified ranked list of candidate links into a first portion of data, a second portion of data, and a third portion of data. The first portion, the second portion, and the third portion may include a same quantity of the modified ranked list of candidate links, different quantities of the modified ranked list of candidate links, and/or the like. In some implementations, more of the modified ranked list of candidate links may be allotted to the first portion of data since the first portion may be utilized to generate the training dataset for the KGE model.

The training system may generate a training dataset for the KGE model based on the first portion of data. The training system may generate a validation dataset for the KGE model based on the second portion of data. The training system may generate a test dataset for the KGE model based on the third portion of data. In other implementations, the training system may utilize different portions of the modified ranked list of candidate links to generate the training dataset, the validation dataset, and/or the test dataset for the KGE model.

The training system may train the KGE model with the training dataset to generate the trained KGE model. As described elsewhere herein, the KGE model may be trained to process a knowledge graph, and identify one or more missing, unseen links between nodes of the knowledge graph. In some implementations, rather than training the KGE model, the training system may obtain the trained KGE model from another system or device that trained the KGE model. In this case, the training system may provide the other system or device with the training dataset, the validation dataset, and/or the test dataset for use in training the KGE model, and may provide the other system or device with updated training, validation, and/or test datasets to retrain the KGE model in order to update the KGE model.

In some implementations, the training system may train the KGE model with the training dataset to generate the trained KGE model, and may process the validation dataset, with the trained KGE model, to validate that the trained KGE model is operating correctly. If the trained KGE model is operating correctly, the training system may process the trained KGE model, with the test dataset, to further ensure that the trained KGE model is operating correctly. A trained KGE model can be said to be operating correctly if it has adequate accuracy, has adequate precision, has adequate recall, is not subject to excessive overfitting, and/or the like. If the trained KGE model is operating excessively incorrectly, the training system may modify the trained KGE model and may revalidate and/or retest the modified KGE model based on the validation dataset and/or the test dataset.

As further shown in FIG. 1H, and by reference number 155, the training system may cause the trained KGE model to be implemented. For example, the training system may provide the trained KGE model to the data structure for storage. A user may utilize a computing device to retrieve the trained KGE model from the data structure and to utilize the trained KGE model to predict missing, unseen links between nodes of knowledge graphs. Alternatively, the training system may provide the trained KGE model to the computing device, and the user may utilize the trained KGE model to predict missing, unseen links between nodes of knowledge graphs.

In this way, the training system identifies training data for training a KGE model. For example, the training system may provide a support decision system for a design of content of knowledge graphs (e.g., training data) used for graph machine learning techniques. The training system may create a focused knowledge graph (e.g., that predicts a specific link type) via a declarative graph construction strategy that creates the focused knowledge graph and via an analytics subsystem that analyzes content of the focused knowledge graph and performance of machine learning predictions based on the focused knowledge graph. Thus, the training system addresses the technical problems associated with the current techniques for updating a KGE model. This, in turn, conserves computing resources, networking resources, and/or the like that would otherwise have been consumed in failing to select the most informative content for the training data, generating an incomplete KGE model based on training the KGE model with insufficient training data, discovering the incomplete KGE model and the insufficient training data, supplementing the insufficient training data and retraining the KGE model with the supplemented training data, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

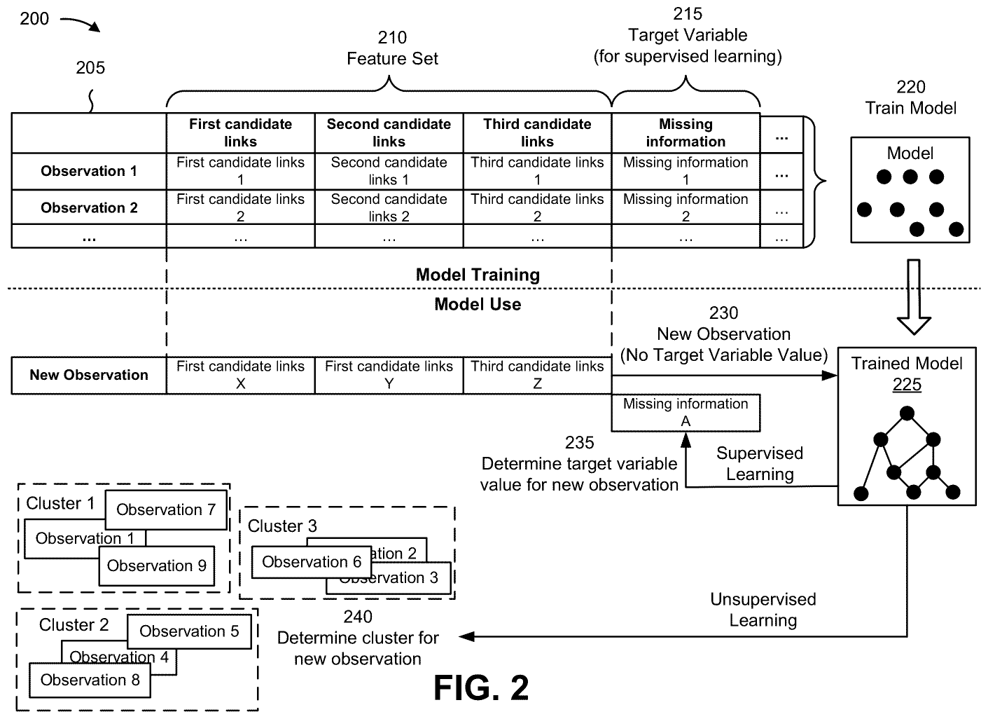

FIG. 2 is a diagram illustrating an example 200 of training and using a machine learning model for predicting missing unseen links between nodes of a knowledge graph. The machine learning model training and usage described herein may be performed using a machine learning system. The machine learning system may include or may be included in a computing device, a server, a cloud computing environment, and/or the like, such as the training system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the training system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the conversion system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of first candidate links, a second feature of second candidate links, a third feature of third candidate links, and so on. As shown, for a first observation, the first feature may have a value of first candidate links 1, the second feature may have a value of second candidate links 1, the third feature may have a value of third candidate links 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be labelled “missing information” and may include a value of missing information 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first candidate links X, a second feature of second candidate links Y, a third feature of third candidate links Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of missing information A for the target variable of the missing information, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first candidate links cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second candidate links cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of thresholds, and/or the like), may be based on a cluster in which the new observation is classified, and/or the like.

In this way, the machine learning system may apply a rigorous and automated process to predict missing unseen links between nodes of a knowledge graph. The machine learning system enables recognition and/or identification of tens, hundreds, thousands, or millions of features and/or feature values for tens, hundreds, thousands, or millions of observations, thereby increasing accuracy and consistency and reducing delay associated with predicting missing unseen links between nodes of a knowledge graph relative to requiring computing resources to be allocated for tens, hundreds, or thousands of operators to manually predict missing unseen links between nodes of a knowledge graph.

As indicated above, FIG. 2 is provided as an example. Other examples may differ from what is described in connection with FIG. 2.

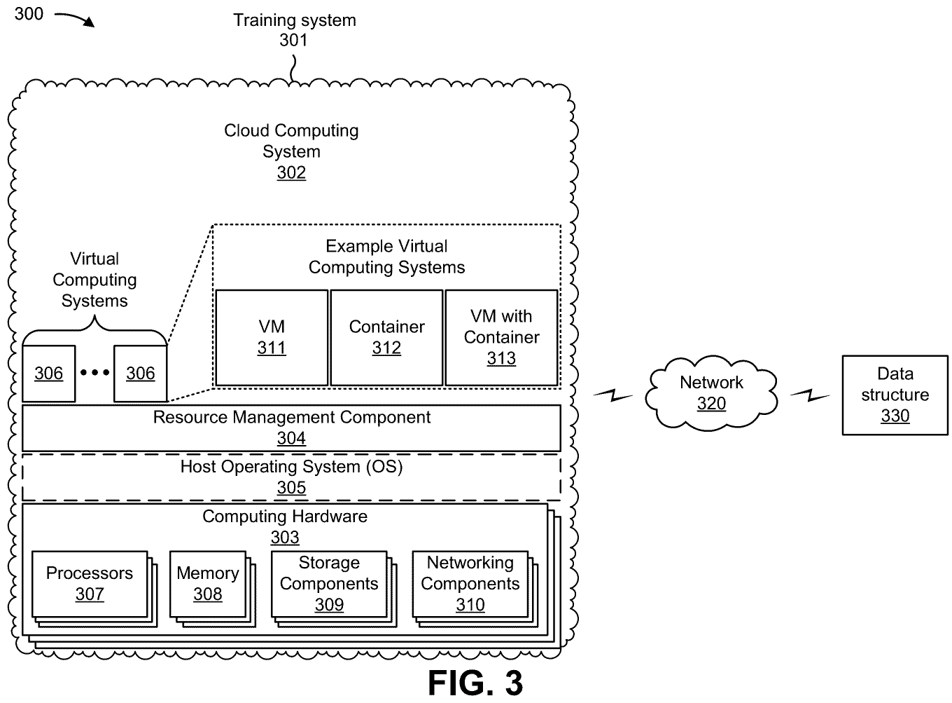

FIG. 3 is a diagram of an example environment 300 in which systems and/or methods described herein may be implemented. As shown in FIG. 3, the environment 300 may include a training system 301, which may include one or more elements of and/or may execute within a cloud computing system 302. The cloud computing system 302 may include one or more elements 303-313, as described in more detail below. As further shown in FIG. 3, the environment 300 may include a network 320 and/or a data structure 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

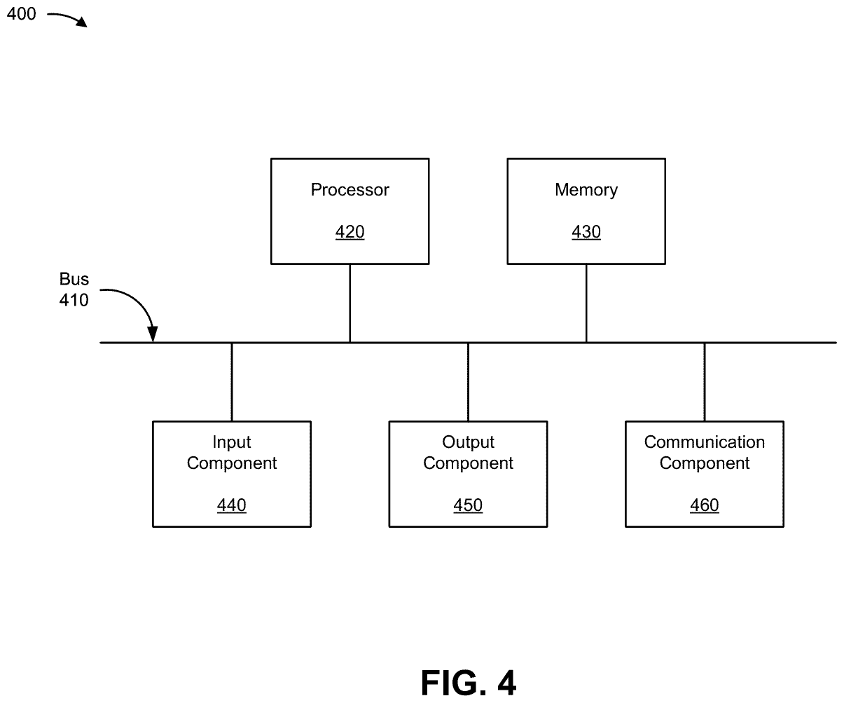

Although the training system 301 may include one or more elements 303-313 of the cloud computing system 302, may execute within the cloud computing system 302, and/or may be hosted within the cloud computing system 302, in some implementations, the training system 301 may not be cloud-based (e.g., may be implemented outside of a cloud computing system) or may be partially cloud-based. For example, the training system 301 may include one or more devices that are not part of the cloud computing system 302, such as device 400 of FIG. 4, which may include a standalone server or another type of computing device. The training system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the training system 301 and/or the data structure 330. In some implementations, the training system 301 and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The input component 440 enables the device 400 to receive input, such as user input and/or sensed inputs. For example, the input component 440 may include a touch screen, a keyboard, a keypad, a mouse, a button, a microphone, a switch, a sensor, a global positioning system component, an accelerometer, a gyroscope, an actuator, and/or the like. The output component 450 enables the device 400 to provide output, such as via a display, a speaker, and/or one or more light-emitting diodes. The communication component 460 enables the device 400 to communicate with other devices, such as via a wired connection and/or a wireless connection. For example, the communication component 460 may include a receiver, a transmitter, a transceiver, a modem, a network interface card, an antenna, and/or the like.

The device 400 may perform one or more processes described herein. For example, a non-transitory computer-readable medium (e.g., the memory 430) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

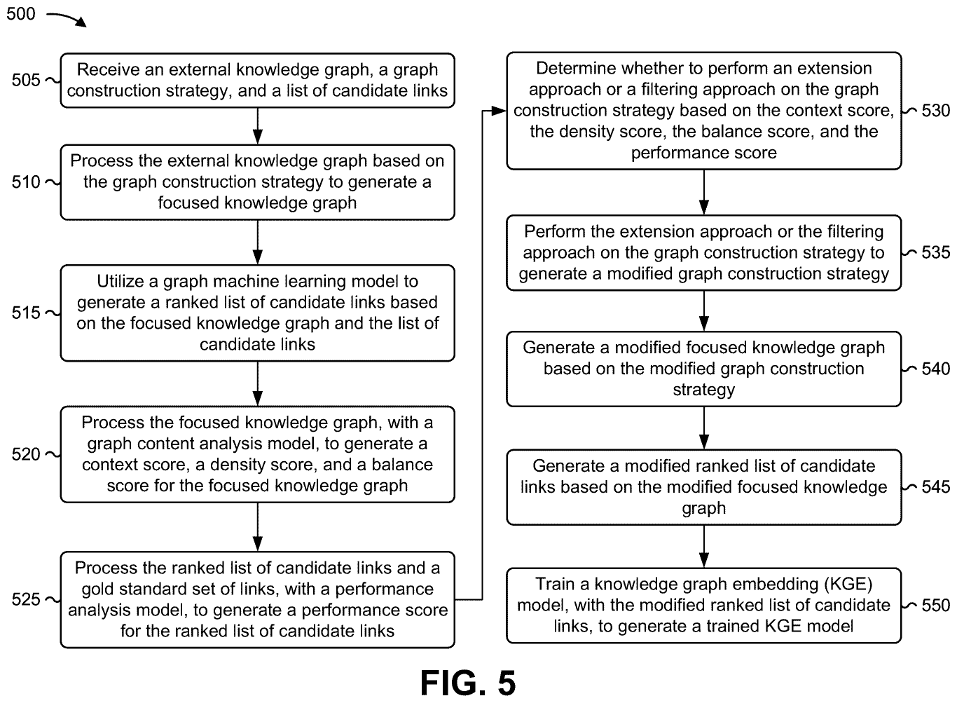

FIG. 5 is a flowchart of an example process 500 for identifying training data for training a KGE model. In some implementations, one or more process blocks of FIG. 5 may be performed by a device (e.g., the training system 301). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving an external knowledge graph, a graph construction strategy, and a list of candidate links (block 505). For example, the device may receive an external knowledge graph, a graph construction strategy, and a list of candidate links, as described above.

As further shown in FIG. 5, process 500 may include processing the external knowledge graph based on the graph construction strategy to generate a focused knowledge graph (block 510). For example, the device may process the external knowledge graph based on the graph construction strategy to generate a focused knowledge graph, as described above. In some implementations, processing the external knowledge graph based on the graph construction strategy to generate the focused knowledge graph includes executing queries of the graph construction strategy, extracting particular connections from the external knowledge graph based on executing the queries, and generating the focused knowledge graph based on the particular connections.

As further shown in FIG. 5, process 500 may include utilizing a graph machine learning model to generate a ranked list of candidate links based on the focused knowledge graph and the list of candidate links (block 515). For example, the device may utilize a graph machine learning model to generate a ranked list of candidate links based on the focused knowledge graph and the list of candidate links, as described above. In some implementations, utilizing the graph machine learning model to generate the ranked list of candidate links includes performing link predictions for the list of candidate links based on the focused knowledge graph, and ranking the list of candidate links based on the link predictions to generate the ranked list of candidate links.

As further shown in FIG. 5, process 500 may include processing the focused knowledge graph, with a graph content analysis model, to generate a context score, a density score, and a balance score for the focused knowledge graph (block 520). For example, the device may process the focused knowledge graph, with a graph content analysis model, to generate a context score, a density score, and a balance score for the focused knowledge graph, as described above. In some implementations, processing the focused knowledge graph, with the graph content analysis model, to generate the context score includes calculating average path lengths of the focused knowledge graph between concept types, and performing a Gaussian mapping of the average path lengths to generate the context score. In some implementations, processing the focused knowledge graph, with the graph content analysis model, to generate the density score includes calculating a quantity of triangular relationships in the focused knowledge graph, and generating the density score based on the quantity of triangular relationships in the focused knowledge graph. In some implementations, processing the focused knowledge graph, with the graph content analysis model, to generate the balance score includes calculating degree distributions associated with the focused knowledge graph, and generating the balance score based on the degree distributions associated with the focused knowledge graph.

As further shown in FIG. 5, process 500 may include processing the ranked list of candidate links and a gold standard set of links, with a performance analysis model, to generate a performance score for the ranked list of candidate links (block 525). For example, the device may process the ranked list of candidate links and a gold standard set of links, with a performance analysis model, to generate a performance score for the ranked list of candidate links, as described above. In some implementations, processing the ranked list of candidate links and the gold standard set of links, with the performance analysis model, to generate the performance score includes processing the ranked list of candidate links, with the KGE model, to generate first performance metrics, processing the gold standard set of links, with the KGE model, to generate second performance metrics, and generating the performance score based on the first performance metrics and the second performance metrics.

As further shown in FIG. 5, process 500 may include determining whether to perform an extension approach or a filtering approach on the graph construction strategy based on the context score, the density score, the balance score, and the performance score (block 530). For example, the device may determine whether to perform an extension approach or a filtering approach on the graph construction strategy based on the context score, the density score, the balance score, and the performance score, as described above.

As further shown in FIG. 5, process 500 may include performing the extension approach or the filtering approach on the graph construction strategy to generate a modified graph construction strategy (block 535). For example, the device may perform the extension approach or the filtering approach on the graph construction strategy to generate a modified graph construction strategy, as described above. In some implementations, performing the extension approach or the filtering approach on the graph construction strategy, to generate the modified graph construction strategy, includes one of performing the extension approach on the graph construction strategy to generate the modified graph construction strategy based on the context score failing to satisfy a context threshold, or performing the filtering approach on the graph construction strategy to generate the modified graph construction strategy based on the balance score failing to satisfy a balance threshold or on the performance score failing to satisfy a performance threshold vale.

In some implementations, performing the extension approach on the graph construction strategy to generate the modified graph construction strategy includes adding edges and edge types to the graph construction strategy to generate the modified graph construction strategy. In some implementations, performing the filtering approach on the graph construction strategy to generate the modified graph construction strategy includes eliminating nodes from the graph construction strategy to generate the modified graph construction strategy.

As further shown in FIG. 5, process 500 may include generating a modified focused knowledge graph based on the modified graph construction strategy (block 540). For example, the device may generate a modified focused knowledge graph based on the modified graph construction strategy, as described above. In some implementations, generating the modified focused knowledge graph based on the modified graph construction strategy includes processing the focused knowledge graph based on the modified graph construction strategy to generate the modified focused knowledge graph.

As further shown in FIG. 5, process 500 may include generating a modified ranked list of candidate links based on the modified focused knowledge graph (block 545). For example, the device may generate a modified ranked list of candidate links based on the modified focused knowledge graph, as described above. In some implementations, generating the modified ranked list of candidate links based on the modified focused knowledge graph includes utilizing the graph machine learning model to generate the modified ranked list of candidate links based on the modified focused knowledge graph and the ranked list of candidate links.

As further shown in FIG. 5, process 500 may include training a KGE model, with the modified ranked list of candidate links, to generate a trained KGE model (block 550). For example, the device may train a KGE model, with the modified ranked list of candidate links, to generate a trained KGE model, as described above.

In some implementations, process 500 includes causing the trained KGE model to be implemented.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, an external knowledge graph, a graph construction strategy, and a list of candidate links;
processing, by the device, the external knowledge graph based on the graph construction strategy to generate a focused knowledge graph;
utilizing, by the device, a graph machine learning model to generate a ranked list of candidate links based on the focused knowledge graph and the list of candidate links;
processing, by the device, the focused knowledge graph, with a graph content analysis model, to generate a context score, a density score, and a balance score for the focused knowledge graph;
processing, by the device, the ranked list of candidate links and a gold standard set of links, with a performance analysis model, to generate a performance score for the ranked list of candidate links;
determining, by the device, whether to perform an extension approach or a filtering approach on the graph construction strategy based on the context score, the density score, the balance score, and the performance score;
performing, by the device, the extension approach or the filtering approach on the graph construction strategy to generate a modified graph construction strategy;
generating, by the device, a modified focused knowledge graph based on the modified graph construction strategy;
generating, by the device, a modified ranked list of candidate links based on the modified focused knowledge graph; and
training, by the device, a knowledge graph embedding (KGE) model, with the modified ranked list of candidate links, to generate a trained KGE model.

2. The method of claim 1, further comprising:
causing the trained KGE model to be implemented.

3. The method of claim 1, wherein processing the external knowledge graph based on the graph construction strategy to generate the focused knowledge graph comprises:
executing queries of the graph construction strategy;
extracting particular connections from the external knowledge graph based on executing the queries; and
generating the focused knowledge graph based on the particular connections.

4. The method of claim 1, wherein utilizing the graph machine learning model to generate the ranked list of candidate links comprises:
performing link predictions for the list of candidate links based on the focused knowledge graph; and
ranking the list of candidate links based on the link predictions to generate the ranked list of candidate links.

5. The method of claim 1, wherein processing the focused knowledge graph, with the graph content analysis model, to generate the context score comprises:
calculating average path lengths of the focused knowledge graph between concept types; and
performing a Gaussian mapping of the average path lengths to generate the context score.

6. The method of claim 1, wherein processing the focused knowledge graph, with the graph content analysis model, to generate the density score comprises:
calculating a quantity of triangular relationships in the focused knowledge graph; and
generating the density score based on the quantity of triangular relationships in the focused knowledge graph.

7. The method of claim 1, wherein processing the focused knowledge graph, with the graph content analysis model, to generate the balance score comprises:
calculating degree distributions associated with the focused knowledge graph; and
generating the balance score based on the degree distributions associated with the focused knowledge graph.

8. A device, comprising:
one or more memories; and
one or more processors, coupled to the one or more memories, configured to:
receive an external knowledge graph, a graph construction strategy, and a list of candidate links;
process the external knowledge graph based on the graph construction strategy to generate a focused knowledge graph;
utilize a graph machine learning model to generate a ranked list of candidate links based on the focused knowledge graph and the list of candidate links;
process the focused knowledge graph, with a graph content analysis model, to generate a context score, a density score, and a balance score for the focused knowledge graph;
process the ranked list of candidate links and a gold standard set of links, with a performance analysis model, to generate a performance score for the ranked list of candidate links;
determine whether to perform an extension approach or a filtering approach on the graph construction strategy based on the context score, the density score, the balance score, and the performance score;
perform the extension approach or the filtering approach on the graph construction strategy to generate a modified graph construction strategy;
generate a modified focused knowledge graph based on the modified graph construction strategy;
generate a modified ranked list of candidate links based on the modified focused knowledge graph; and
train a knowledge graph embedding (KGE) model, with the modified ranked list of candidate links, to generate a trained KGE model; and
cause the trained KGE model to be implemented.

9. The device of claim 8, wherein the one or more processors, to process the ranked list of candidate links and the gold standard set of links, with the performance analysis model, to generate the performance score, are configured to:
process the ranked list of candidate links, with the KGE model, to generate first performance metrics;
process the gold standard set of links, with the KGE model, to generate second performance metrics; and
generate the performance score based on the first performance metrics and the second performance metrics.

10. The device of claim 8, wherein the one or more processors, to perform the extension approach or the filtering approach on the graph construction strategy to generate the modified graph construction strategy, are configured to one of:
perform the extension approach on the graph construction strategy to generate the modified graph construction strategy based on the context score failing to satisfy a context threshold; or
perform the filtering approach on the graph construction strategy to generate the modified graph construction strategy based on the balance score failing to satisfy a balance threshold or on the performance score failing to satisfy a performance threshold.

11. The device of claim 8, wherein the one or more processors, to perform the extension approach on the graph construction strategy to generate the modified graph construction strategy, are configured to:
add edges and edge types to the graph construction strategy to generate the modified graph construction strategy.

12. The device of claim 8, wherein the one or more processors, to perform the filtering approach on the graph construction strategy to generate the modified graph construction strategy, are configured to:
eliminate nodes from the graph construction strategy to generate the modified graph construction strategy.

13. The device of claim 8, wherein the one or more processors, to generate the modified focused knowledge graph based on the modified graph construction strategy, are configured to:
process the focused knowledge graph based on the modified graph construction strategy to generate the modified focused knowledge graph.

14. The device of claim 8, wherein the one or more processors, to generate the modified ranked list of candidate links based on the modified focused knowledge graph, are configured to:
utilize the graph machine learning model to generate the modified ranked list of candidate links based on the modified focused knowledge graph and the ranked list of candidate links.

15. A non-transitory computer-readable medium storing a set of instructions, the set of instructions comprising:
one or more instructions that, when executed by one or more processors of a device, cause the device to:
receive an external knowledge graph, a graph construction strategy, and a list of candidate links;
process the external knowledge graph based on the graph construction strategy to generate a focused knowledge graph;
utilize a graph machine learning model to generate a ranked list of candidate links based on the focused knowledge graph and the list of candidate links;
process the focused knowledge graph, with a graph content analysis model, to generate a context score, a density score, and a balance score for the focused knowledge graph;
process the ranked list of candidate links and a gold standard set of links, with a performance analysis model, to generate a performance score for the ranked list of candidate links;
determine whether to perform an extension approach or a filtering approach on the graph construction strategy based on the context score, the density score, the balance score, and the performance score;
perform the extension approach on the graph construction strategy to generate a modified graph construction strategy based on the context score failing to satisfy a context threshold;
perform the filtering approach on the graph construction strategy to generate the modified graph construction strategy based on the balance score failing to satisfy a balance threshold or on the performance score failing to satisfy a performance threshold;
generate a modified focused knowledge graph based on the modified graph construction strategy;
generate a modified ranked list of candidate links based on the modified focused knowledge graph; and
train a knowledge graph embedding (KGE) model, with the modified ranked list of candidate links, to generate a trained KGE model.

16. The non-transitory computer-readable medium of claim 15, wherein the one or more instructions, that cause the device to process the external knowledge graph based on the graph construction strategy to generate the focused knowledge graph, cause the device to:
execute queries of the graph construction strategy;
extract particular connections from the external knowledge graph based on executing the queries; and
generate the focused knowledge graph based on the particular connections.

17. The non-transitory computer-readable medium of claim 15, wherein the one or more instructions, that cause the device to utilize the graph machine learning model to generate the ranked list of candidate links, cause the device to:
perform link predictions for the list of candidate links based on the focused knowledge graph; and
rank the list of candidate links based on the link predictions to generate the ranked list of candidate links.

18. The non-transitory computer-readable medium of claim 15, wherein the one or more instructions, that cause the device to process the focused knowledge graph, with the graph content analysis model, to generate the context score, the density score, and the balance score, cause the device to:
calculate average path lengths of the focused knowledge graph between concept types;
perform a Gaussian mapping of the average path lengths to generate the context score;
calculate a quantity of triangular relationships in the focused knowledge graph;
generate the density score based on the quantity of triangular relationships in the focused knowledge graph;
calculate degree distributions associated with the focused knowledge graph; and
generate the balance score based on the degree distributions associated with the focused knowledge graph.

19. The non-transitory computer-readable medium of claim 15, wherein the one or more instructions, that cause the device to process the ranked list of candidate links and the gold standard set of links, with the performance analysis model, to generate the performance score, cause the device to:
process the ranked list of candidate links, with the KGE model, to generate first performance metrics;
process the gold standard set of links, with the KGE model, to generate second performance metrics; and
generate the performance score based on the first performance metrics and the second performance metrics.

20. The non-transitory computer-readable medium of claim 15, wherein the one or more instructions, that cause the device to generate the modified focused knowledge graph based on the modified graph construction strategy, cause the device to:
process the focused knowledge graph based on the modified graph construction strategy to generate the modified focused knowledge graph.
